(19) United States
(12) Patent Application Publication
(10) Pub. No.: US 2012/0229068 A1
(43) Pub. Date: Sep. 13, 2012

(54) INVERTER

(75) Inventors: Robert Januschevski, Tettnang (DE); Kai Borntrager, Langenargen (DE)

(73) Assignee: ZF Friedrichshafen AG, Friedrichshafen (DE)

(21) Appl. No.: 13/508,430

(22) PCT Filed: Oct. 29, 2010
(86) PCT No.: PCT/EP2010/066424

§ 371 Date: May 7, 2012

(30) Foreign Application Priority Data
Nov. 11, 2009 (DE) 10 2009 046 617.7

(51) Int. Cl. H02P 23/00

(52) U.S. Cl. 318/501

(57) ABSTRACT

An inverter, particularly for supplying energy to a three-phase motor (3) of a motor vehicle, where the inverter comprises a half bridge (1a, 1b, 1c) for electrically connecting to the three-phase motor (3). The half-bridge (1a, 1b, 1c) comprises a short circuit element (8) which is electrically conductively connected to an input (6b) and an output (6c) of a power semiconductor switch (5a; 5b) of the half bridge (1a, 1b, 1c). The short circuit element generates a short circuit, between the input (6b) and the output (6c) of the power semiconductor switch (5a; 5b), depending on the voltage value of a voltage present between the input (6b) and the output (6c) of the power semiconductor switch (5a; 5b).

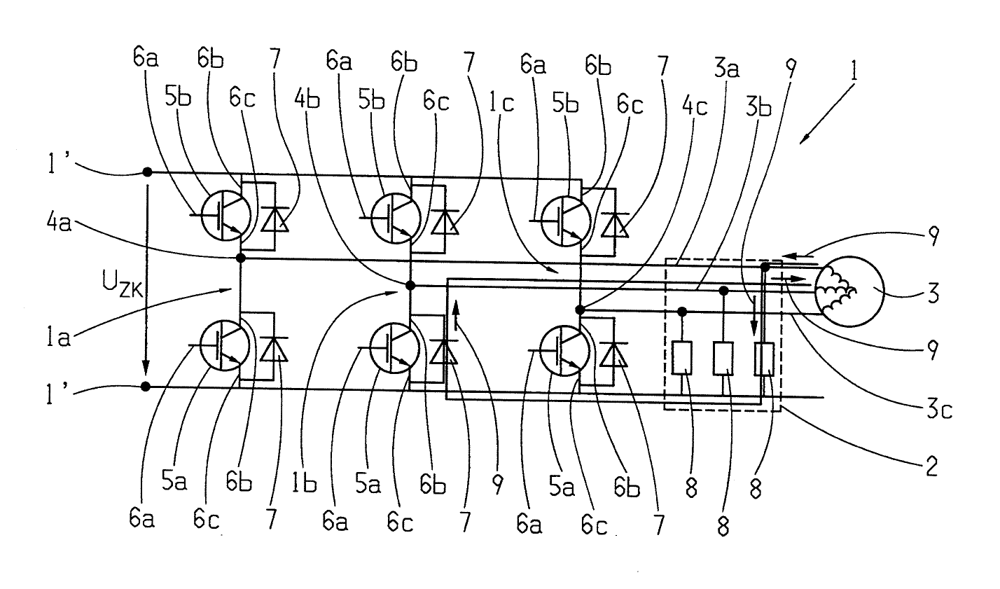

This application is a National Stage completion of PCT/EP2010/066424 filed Oct. 29, 2010, which claims priority from German patent application serial no. 10 2009 046 617.7 filed Nov. 11, 2009.

### FIELD OF THE INVENTION

The present invention relates to an inverter.

### BACKGROUND OF THE INVENTION

Converters and the like are used for controlling electric machines, wherein the machines are supplied, for example, by means of a direct current source, for instance a battery; however, one or more alternating current phases are required for operation. Such machines are, particularly those in the field of motor vehicle drive engineering, such as three-phase motors, for instance permanently excited or externally excited synchronous motors.

A converter comprises a motor-side inverter, or respectively a drive inverter, for converting direct voltage from, for example, an intermediate circuit of the converter, particularly from an intermediate circuit with an intermediate circuit capacitor, into an alternating voltage at the desired frequency for controlling the direction of rotation and the rotational speed of the three-phase motor to be driven. Such drive inverters are used in particular in motor vehicles, for example in electrically driven motor vehicles or in vehicles with a hybrid drive, wherein the three-phase motor is designed as vehicle drive motor.

Such vehicle drive motors, particularly permanently excited synchronous motors, typically display the design-dependent behavior that during operation a counter-voltage, or respectively an internal voltage (synchronous generated voltage), is induced which increases with increasing rotational speed, and which at very high rotational speeds is supplied, or fed back, into the intermediate circuit particularly by means of the free-wheeling diodes of the (drive) inverter, and can lead to damage in the converter or the inverter, the battery, and further components (reverse voltage transfer). In the prior art, in order to be able to avoid this damage, while still being able to operate the motor at high speeds, a field weakening is applied above the rated rotational speed in order to avoid such a damaging reverse voltage transfer. Nevertheless, damage to the converter or further components is possible even with the use of field weakening, particularly if a motor is operated above the rated rotational speed (field weakening operation), and a field weakening current can no longer be maintained, for example. This can be caused by malfunctioning control electronics, for example.

In order to protect the converter from damaging reverse voltage transfer in the case of an unintentional voltage increase on the side of the alternating voltage (thus, originating from the motor), the prior art proposes different protective circuits. Typically, for this purpose, power semiconductor circuits of the converter, or its motor side inverter, and thus the respective motor terminals connected therewith, are short-circuited for example. Short-circuiting via the bridge circuit can prevent damage to the intermediate circuit capacitor, a battery, the power switch, etc., for example, and with it the converter, caused by the induced voltage as a consequence of the rotation of the rotor. The known arrangements have a weakness however, in that in most cases the short circuit must be performed actively by control electronics of the inverter. In the event that the control electronics fail, no protection mechanism is provided against damage which occurs due to the voltage induced in the synchronous machine, or in the motor.

The document DE 102 51 977 A1 discloses a synchronous motor with an inverter, where a complex protection mechanism against reverse voltage transfer is connected to the winding phases, where the protection mechanism interacts with the control logic of the inverter for detecting a failure, or for protection against reverse voltage transfer. The document DE 298 13 080 U1, shows a further protection mechanism, connected to the windings of a motor, for protecting against reverse voltage transfer, where the protection mechanism in turn has electronics connected to the control logic for producing the protection function. This system is also complex and costly to produce. The document DE 198 35 576 A1 discloses a control system for a permanently excited electric motor which contains a unit to detect operating conditions in order to short circuit, if required, the power semiconductor switch by means of a control arrangement of the inverter. The arrangement, as with the prior arrangements, is also complex, costly and cannot be implemented without control logic.

### SUMMARY OF THE INVENTION

Proceeding from this background, the object addressed by the present invention is to solve the problems described above, and to propose an inverter which allows short circuiting of the motor terminals of a three-phase motor for protecting against reverse voltage transfer in a simple manner and without involving the control logic of the inverter.

An inverter according to the invention, particularly for the energy supply of a three-phase motor of a motor vehicle, is proposed where the inverter comprises a half bridge for electrically connecting to the three-phase motor, where the half bridge comprises an electrically conductive short circuit element electrically connected to an input and an output of a power semiconductor switch of the half bridge, where the short circuit element generates a short circuit between the input and the output of the power semiconductor switch depending on the voltage value (magnitude and polarity) of a voltage present between the input and the output of the power semiconductor switch.

One embodiment of the inverter according to the invention proposes that each half bridge of the inverter is provided with a short circuit element electrically conductively connected to an input and an output of a power semiconductor switch of the half bridge, where the short circuit element generates a short circuit between the input and the output of the power semiconductor switch depending on the voltage value (magnitude and polarity) of a voltage present between the input and the output of the power semiconductor switch of the respective half bridge.

In yet a further embodiment of the inverter according to the invention, due to each short circuit there, current flow is possible through the short circuit element in the direction from the input to the output of the respective power semiconductor switch.

In one embodiment of an inverter according to the invention, due to short circuit, in each case, current flow through the respective short circuit element is possible, in the opposing direction to the current flow direction through a free-wheeling diode connected to the input and the output of the respective power semiconductor switch.

Further, an inverter is proposed wherein the short circuit element is disposed in the reverse direction between the input and the output, wherein the short circuit element is conductive in the reverse direction by creating a short circuit after reaching a defined voltage present between the input and the output.

In one embodiment of the inverter according to the invention, the short circuit element can comprise a single-use short circuit element and/or a reusable short circuit element. The short circuit element can comprise a comparator and/or a power switch, particularly a semiconductor switch or a mechanical switch. The short circuit element can comprise a diode and/or a gas discharge tube and/or a varistor. In a further embodiment of the inverter, the short circuit element can include an AC current diverter and/or a semiconductor conducting by means of the destruction thereof.

Furthermore, a drive arrangement, particularly of a motor vehicle, is proposed which comprises a three-phase motor, wherein for supplying electrical energy a winding strand of the three-phase motor is electrically conductively connected to the half bridge of an inverter according to the invention.

In a further drive arrangement according to the invention, every winding strand of the three-phase motor is electrically conductively connected to a respective half bridge of the inverter.

In yet a further drive arrangement according to the invention, the three-phase motor is a synchronous motor, particularly a permanently or externally excited three-phase motor.

Further features and advantages of the invention arise from the following description of example embodiments of the invention based on the FIGURE of the drawings which show individual units essential to the invention, and from the claims. The individual features can be implemented alone or combined in any combination in a variant of the invention.

### BRIEF DESCRIPTION OF THE DRAWINGS

Preferred embodiments of the invention are explained in the following in more detail using the attached drawing. The sole FIGURE shows:

an example of a bridge circuit of an inverter according to a possible embodiment of the invention.

### DETAILED DESCRIPTION OF THE PREFERRED EMBODIMENTS

Elements that are the same or have the same function in the following description and the FIGURE have the same reference numbers.

The sole FIGURE shows a bridge circuit 1 of a drive inverter, or inverter, according to the invention, comprising a short circuit arrangement 2, particularly for protecting against reverse voltage transfer from a motor, for example, a three-phase motor 3, particularly an externally excited or permanently excited synchronous motor. The (drive) inverter is, for example, part of a converter known in the prior art.

A converter comprises in a known manner, for example, a rectifier (not shown) that supplies an intermediate circuit, in which an intermediate circuit capacitor is disposed, for example. The intermediate circuit supplies an intermediate circuit voltage U_{ZK} for example, particularly as a direct voltage, at the input 1′ of the inverter 2 for example, for the bridge circuit 1 of the inverter, for generating the alternating voltage provided for operating the motor. The inverter generates an alternating voltage for example, as an output voltage with variable voltage and frequency, in order to control the direction of rotation and rotational speed of the three-phase motor 3 connectable or connected thereto, for example.

The intermediate circuit voltage U_{ZK} is present at the input terminal 1′, for example, of the bridge circuit 1, which has a half bridge 1a, 1b, 1c, for example, each of which is electrically connectable or connected, for example via a center tap 4a, or 4b, 4c, in a known manner to a winding strand 3a, 3b, 3c of the three-phase motor 3. Here, the three-phase motor 3 is designed as a three-phase motor, whose winding strands 3a, 3b, 3c are each supplied by a half bridge 1a, 1b, 1c, for example. A voltage, or a potential, of predetermined polarity is delivered for a defined duration to each strand 3a, 3b, 3c of the three-phase motor 3 by the respective half bridge 1a, 1b, 1c. For this purpose, each of the power semiconductor switches 5a, 5b of the half bridges 1a, 1b, 1c are each correspondingly controlled in a known manner by means of control logic, for example.

A half bridge 1a, 1b, 1c comprises, for example, a first (lower) power semiconductor switch 5a, and a second (upper) power semiconductor switch 5b, which are in the form, for example, of a bipolar transistor with an insulated gate electrode (insulated gate bipolar transistor, IGBT) or as a field-effect transistor (FET), in the form, for example, of a metal-oxide-semiconductor field-effect transistor (MOSFET). The power semiconductor switches 5a, 5b are designed and appropriately dimensioned, particularly for the voltages occurring in a converter or in the drive inverter, for example. However, further power semiconductor switches are also conceivable.

The power semiconductor switches 5a, 5b each comprise a control input 6a, for example in the form of a gate electrode, and an input 6b, for example in the form of a collector electrode (IGBT) or a drain electrode (MOSFET) and an output 6c, for example in the form of an emitter electrode (IGBT) or source electrode (MOSFET). A free-wheeling diode 7 is connected in parallel in a customary manner between the input 6b and the output 6c, for example, particularly connected in parallel in the reverse direction.

The power semiconductor switches 5a (lower row), 5b (upper row) are, as specified above, controlled via the respective control input 6a thereof, or control connection, in a known manner, for example by control electronics (not shown), where as a result of the control, a short circuit can be produced between the input 6b and the output 6c, in other words, the power semiconductor 5a or 5b is switched on.

The inverter according to the invention comprises a short circuit arrangement 2, which is formed by a short circuit element 8 for example, particularly formed by a short circuit element 8 for each half bridge 1a, or 1b, 1c. Each short circuit element 8 is disposed for example at a power semiconductor switch 5a of the lower row, where a short circuit element 8 for example is disposed at the power semiconductor switches 5b of the upper row.

Here, the short circuit element 8 is in each case in the associated half bridge 1a, 1b, 1c electrically connected to the input 6b of the power semiconductor switch 5a and to the output 6c thereof, and therefore can bridge these in the case of a short circuit. Additionally, the input 6b is electrically connected to the center tap 4a or 4b, 4c of the associated half bridge 1a, or 1b, 1c. The short circuit element 8 is disposed or connected in each case in parallel between, or in parallel to, the input 6b and the output 6c of the respective power semiconductor switch 5a, and is disposed in parallel to the respective free-wheeling diode 7 of the power semiconductor switch 5a, wherein the free-wheeling diode is also connected respectively to the input 6b and the output 6c of the power semiconductor switch 5a or 5b.

According to the invention, it is also provided to dispose a short circuit element 8 in parallel to a three-wheeling diode 7, or to an input 6b and an output 6c of a power semiconductor switch 5b of the upper row, in particular for each half bridge 1a, 1b, 1c. With such an arrangement, the arrangement at the power semiconductor switches 5a of the lower row can be omitted.

The short circuit element 8 of the short circuit arrangement 2 is provided according to the invention so that in case of a reverse voltage transfer, for instance if the inverter fails, the terminal voltage of the motor, or the voltage of the three-phase motor 3, is set essentially to zero. The short circuit can be attained solely by the short circuit element 8 in the form of one or more suitably selected components, and particularly without interaction, for instance with the control logic of the converter, in this respect self-sufficiently.

The selected components, for example due to the dimensioning or material properties thereof, define a voltage value as a threshold value, thus they define the voltage starting from which a short circuit is produced. The short circuit elements 8 are each, for example, high impedance, particularly in the provided reverse direction thereof, for example from the input 6b toward the output 6c, until the voltage present at them, or between the input 6b and the output 6c respectively attains the provided threshold voltage. Starting from the threshold voltage, or after exceeding the threshold voltage, at the respective motor terminals, or between the input 6b and the output 6c of the respective power semiconductor switch, the short circuit elements 8 each generate a respective short circuit between the input 6b and the output 6c. The elements are each in this regard conducting in the reverse direction thereof. In this regard, a short circuit element 8 connects the input 6b and the output 6c of a respective power semiconductor switch 5a or 5b, in a defined manner with high impedance or by means of a generated short circuit, depending on the voltage value of the voltage present between the input 6b and the output 6c.

The inverter is designed such that due to the short circuit by the short circuit element 8, as a consequence of reaching the threshold value, current flow through the respective short circuit element 8 is possible in the direction from the input 6b to the output 6c of the respective power semiconductor switch 5a or 5b. In other words, in the case of attaining the threshold voltage, the short circuit element 8 is conducting in the reverse direction thereof due to the generated short circuit. The reverse direction of the short circuit element 8 disposed between the input 6b and the output 6c corresponds particularly to the reverse direction of the free-wheeling diode 7 for example.

Due, in particular, to the short circuit, for example between the input 6b and the output 6c, current flow is possible through the respective short circuit element 8 in the opposing direction, or antiparallel, to the intended or provided current flow direction through the free-wheeling diode 7 connected to the input 6b and the output 6c of the respective power semiconductor switch. Thus, a current 9 can flow, for example from a winding strand 3a of the motor 3 via the short circuit element 8, and a free-wheeling diode 7 for example to a further winding strand 3b of the motor 3 for example.

Various components can be used as a short circuit element 8 for guaranteeing this function, for instance elements that are externally switchable or elements that are integrated into the inverter. A short circuit element 8 can comprise an active component (element), which allows control for example, or can comprise a passive component (element), or can be designed as such in each case. The short circuit element 8 can be a single-use short circuit element 8, which can be used only once, or can be a reusable short circuit element 8, which can be used repeatedly for example.

A diode with a defined reverse voltage that becomes conductive in the reverse direction as soon as the reverse voltage is exceeded by the terminal voltage of the motor 3, can be considered as a single-use element for example. Until the reverse voltage is reached, the diode, for instance, has high impedance in the reverse direction. Any semiconductors that become conductive as a result of the failure thereof, for example, due to the fed back voltage present between the input 6b and the output 6c, and thus, generates a short circuit between the input 6b and the output 6c, can be considered. Such single-use short circuit elements 8, in particular, generate a permanent short circuit. Normal operation of the electrical vehicle drive, i.e., the three-phase motor 3, by means of the inverter is no longer possible. The short circuit element 8 must be replaced for example.

A reusable short circuit element 8 can comprise, for example, an arrangement of several components, for instance a device comprising a comparator, which detects a voltage surge or exceeding the threshold voltage, and as a result can actuate a power switch, whose conductivity (on/off) can be controlled depending on the detected voltage value. The power switch can be a semiconductor switch, for example a transistor switch, or for example a mechanical switch, for instance a relay.

A gas discharge tube, for example, can be used as a reusable short circuit element 8; e.g. a gas discharge tube connected in parallel with a varistor can also be used. Furthermore, any AC current diverter, for example, can be used as a short circuit element 8. The solution with reusable short circuit elements 8 has the tendency to be more expensive. After decreasing the alternating voltage to approximately zero volts, the electric drive, or the three-phase motor 3, can be again operated.

It is conceivable to provide different types of short circuit elements 8 within an inverter; for example, for each half bridge 1a, 1b, 1c, providing different types for forming a short circuit arrangement 2. All of the short circuit elements 8 according to the invention, or the short circuit arrangement 2 according to the invention, generate the short circuit self-sufficiently, or independently, i.e., solely depending on the voltage present at the short circuit element 8. In this respect, a short circuit element 8 or short circuit arrangement 2 according to the invention, is independent of a control of the, or by the, inverter(s), converter(s) or motor(s), etc. Further components, particularly a circuit of external signal sources such as those of control logic for the converter or inverter, which control the power semiconductor, for example, are not additionally provided for generating the short circuit according to the invention.

The generation of a short circuit according to the invention, in which through a short circuit element 8, particularly connected to a free-wheeling diode 7, a short circuit is generated between each of two terminals of the motor 3 at least starting from a potentially damaging reverse voltage transfer, or from exceeding a defined threshold value, produces a short circuit braking torque for example, which can cause braking of the motor in a motor decoupled from the drive train, i.e., the rotational speed is reduced to zero. With a motor connected to the drive train, for example, the entire drive train is braked.

A current 9 flowing in the three-phase motor 3 and inverter flows, in the case of the generated short circuit, for example, from a first terminal of the three-phase motor 3 connected to the center tap 4a, through the short circuit element 8 of the short circuit arrangement 2 via the free-wheeling diode 7, back to a further terminal of the motor 3 connected to the center tap 4b.

### REFERENCE CHARACTERS

1 bridge circuit

1′ input terminals

1a, 1b, 1c half bridge

2 short circuit arrangement

3 motor

3a, 3b, 3c winding strand

4a, 4b, 4c half bridge

5a power semiconductor switch (lower row)

5b power semiconductor switch (upper row)

6a control input of the power semiconductor switch

6b input of the power semiconductor switch

6c output of the power semiconductor switch

7 free-wheeling diode

8 short circuit element

9 current

1-12. (canceled)

13. An inverter for supplying energy to a three-phase motor (3) of a motor vehicle, the inverter comprising:
a half bridge (1a, 1b, 1c) for electrically connecting to the three-phase motor (3),
the half-bridge (1a, 1b, 1c) comprising a short circuit element (8) which is electrically conductively connected to an input (6b) and an output (6c) of a power semiconductor switch (5a; 5b) of the half bridge (1a, 1b, 1c) and generating a short circuit, between the input (6b) and the output (6c) of the power semiconductor switch (5a; 5b), depending on a voltage value of a voltage present between the input (6b) and the output (6c) of the power semiconductor switch (5a; 5b).

14. The inverter according to claim 13, wherein each half-bridge (1a, 1b, 1c) of the inverter is provided with a short circuit element (8) which is electrically conductively connected to an input (6b) and an output (6c) of a power semiconductor switch (5a; 5b) of the half bridge (1a, 1b, 1c), and which generates a short circuit in a defined manner between the input (6b) and the output (6c) of the power semiconductor switch (5a; 5b) depending on the voltage value of a voltage present between the input (6b) and the output (6c) of the power semiconductor switch (5a; 5b) of the respective half bridge (1a, 1b, 1c).

15. The inverter according to claim 13, wherein due to the respective short circuit, current flow is possible through the respective short circuit element (8) in a direction from the input (6b) to the output (6c) of the respective power semiconductor switch (5a; 5b).

16. The inverter according to claim 13, wherein due to the short circuit, current flow is possible in each case through the respective short circuit element (8) in an opposite direction to a current flow direction through a free-wheeling diode (7) connected to the input (6b) and the output (6c) of the respective power semiconductor switch (5a; 5b).

17. The inverter according to claim 13, wherein the short circuit element (8) is disposed in a reverse direction between the input (6b) and the output (6c), the short circuit element (8) becomes conductive in the reverse direction due to creation of the short circuit after attaining a defined voltage value present between the input (6b) and the output (6c).

18. The inverter according to claim 13, wherein the short circuit element (8) comprises at least one of a single-use short circuit element and a reusable short circuit element.

19. The inverter according to claim 13, wherein the short circuit element (8) comprises at least one of a comparator and a power switch.

20. The inverter according to claim 13, wherein the short circuit element (8) comprises at least one of a diode, a gas discharge tube and a varistor.

21. The inverter according to claim 13, wherein the short circuit element (8) comprises at least one of an AC current diverter and a semiconductor conducting due to destruction thereof.

22. A drive arrangement in combination with an inverter for a motor vehicle containing a three-phase motor (3),
wherein for supplying electrical energy, a winding strand (3a, 3b, 3c) of the three-phase motor (3) is electrically conductively connected to the half bridge (1a, 1b, 1c) of the inverter,
the inverter comprises a half bridge (1a, 1b, 1c) for electrically connecting to the three-phase motor (3), and
the half-bridge (1a, 1b, 1c) comprises a short circuit element (8) which is electrically conductively connected to an input (6b) and an output (6c) of a power semiconductor switch (5a; 5b) of the half bridge (1a, 1b, 1c) and which generates a short circuit between the input (6b) and the output (6c) of the power semiconductor switch (5a; 5b) depending on a voltage value of a voltage present between the input (6b) and the output (6c) of the power semiconductor switch (5a; 5b).

23. The drive arrangement according to claim 22, wherein each winding strand (3a, 3b, 3c) of the three-phase motor (3) is electrically conductively connected to a half bridge (1a, 1b, 1c) of the inverter.

24. The drive arrangement according to claim 22, wherein the three-phase motor (3) is one of a synchronous motor, a permanently excited motor and an externally excited synchronous motor.

25. An inverter, particularly for supplying energy to a three-phase motor of a motor vehicle, the inverter comprising:
three half bridges and each of the three half bridges being electrically connected to a respective phase of the three-phase motor, and
each of the three half-bridges comprising a short circuit element which is electrically conductively connected to an input and an output of a power semiconductor switch and which generates a short circuit between the input and the output of the power semiconductor switch depending on value of voltage that is present between the input and the output of the power semiconductor switch.
